(19) United States
(12) Patent Application Publication
(10) Pub. No.: US 2015/0170254 A1
(43) Pub. Date: Jun. 18, 2015

(54) SYSTEM AND METHOD FOR PROCESSING AN ELECTRONIC ORDER

(71) Applicant: Unijunction (Pty) Ltd, Stellenbosch, Western Cape (ZA)

(72) Inventors: Ernst Heinz Van Biljon, Stellenbosch (ZA); Wessel Antonie Pieterse, Stellenbosch (ZA)

(21) Appl. No.: 14/407,747

(22) PCT Filed: Jun. 27, 2013
(86) PCT No.: PCT/IB2013/055287

§ 371 Date: Dec. 12, 2014

(30) Foreign Application Priority Data
Jun. 28, 2012 (ZA) 2012/04822

(51) Int. Cl. G06Q 30/06

(52) U.S. Cl. CPC G06Q 30/0635

(57) ABSTRACT

A system (100) and method for processing an electronic order is provided. The system comprises a remotely accessible server (102) having a first interface (108) with an ordering entity (106), a second interface (112) with a number of vendors (110), and a third interface (116) with a number of delivery providers (114). The server (102) is configured to receive an order placed by a consumer (104) with the ordering entity (106) through the first interface (108), transmit the order to a vendor (110) by means of the second interface (112) and once the order is ready for fulfillment, transmit a delivery instruction to a delivery provider (114) through the third interface (116). The server (102) is further configured to compute fees due to the vendor (110) and delivery provider (114), update a ledger account with the applicable amounts and, at regular intervals, transmit an instruction to a payment gateway (120) for settlement of the amounts due to each party.

### FIELD OF THE INVENTION

This invention relates to a system and a method for processing an electronic order.

### BACKGROUND TO THE INVENTION

Electronic commerce (e-commerce) systems exist in which an individual consumer can place an order for physical goods on a website and those goods are then subsequently delivered to the consumer. An example of such a system is the well-known e-commerce provider Amazon.com™.

Typically, existing e-commerce systems apply centralized dispatch and ordering processes, so that orders placed are processed and packaged at a central location before being dispatched and delivered by traditional delivery means such as the postal service or third party courier companies. Deliveries generally take at least one day to reach the consumer and in many cases several days or more.

Some larger vendors, such as supermarket chain-stores, have websites on which shopping orders can be placed. These orders are often delivered within a timeframe of several hours. Rather than being routed from a centralized dispatch warehouse, these orders may be fulfilled from a nearby supermarket chain-store, cutting down the delivery time. However, these systems require complex inventory, delivery and logistics management, which must all be set up and controlled by the vendor itself.

It would be advantageous to have a system which connects vendors, consumers and delivery providers according to their mutual operational proximities in a seamless manner so that consumers can receive delivery of orders placed from nearby vendors in a very short timeframe, without the vendors and delivery providers having the administrative burden of tracking inventory and payments.

It is to be understood that the term “vendor” as used in this specification should be widely construed to include any type of vendor of tangible or intangible goods and any type of service provider.

### SUMMARY OF THE INVENTION

In accordance with the invention there is provided a method for processing an electronic order, the method carried out at a remotely accessible server and comprising the steps of:
through a first interface with an ordering entity, receiving an order for an item placed by a consumer with the ordering entity, the order including an identification of the item ordered, delivery details, a price for the item, and a vendor from whom the item is desired;
through a second interface with a number of vendors, transmitting the order to the vendor identified in the order;
receiving a notification from the vendor indicating that the order has been accepted and subsequently receiving a notification from the vendor that the order is ready for fulfillment;
upon receiving a notification that the order is ready for fulfillment, though a third interface with a number of delivery providers, transmitting a delivery instruction to a delivery provider able to fulfil the delivery,
receiving a notification from the delivery provider that the delivery has been fulfilled,
upon fulfillment of the delivery:
   computing a delivery fee due to the delivery provider for delivery of the item based on a pre-set delivery fee formula,
   updating a ledger account of the delivery provider with the delivery fee,
   updating a ledger account of the vendor with the price for the item minus the delivery fee,
      at regular intervals, determining the amount owed between the vendor and the delivery provider and optionally instructing a payment gateway to facilitate settlement thereof.

Further features of the invention provide for the ordering entity to be selected from a mobile device application, a call centre, an electronic commerce website, and a point of sale.

Still further features of the invention provide for the first interface to include an application program interface that defines the format with which the ordering entity must transmit the order to the remotely accessible server.

Yet further features of the invention provide for the vendor to receive a notification of the fulfillment of the delivery so that the vendor is able to track the order from the time the order is placed until it is fulfilled; and for the vendor to be able to track each order on a visual display.

Further features of the invention provide for the delivery provider to be able to include the details of multiple delivery agents with the remotely accessible server; for each delivery agent to have a ledger account with the remotely accessible server; and for the ledger account of a specific delivery agent to be updated upon that delivery agent fulfilling a delivery.

Still further features of the invention provide for the item to be a physical item and the delivery provider must physically deliver the item to the consumer; alternatively, the item may be a virtual item and the delivery provider delivers the item to the consumer through an electronic communications channel.

Yet further features of the invention provide for the delivery details to include a geographic location of the consumer; for the remotely accessible server to identify a retailer outlet of a vendor which is closest to the location of the consumer, to thereby reduce the required travelling distance and time for the delivery of the ordered item; and for the geographic location of the consumer to be obtained from a Global Positioning System (GPS) coordinate of a geo-location feature of a mobile device application.

The invention extends to a system for processing an electronic order, the system comprising a remotely accessible server having:
a first interface with an ordering entity, by means of which the server is configured to receive an order for an item placed by a consumer with the ordering entity, the order including an identification of an item ordered, delivery details, a price for the item, and a vendor from whom the item is desired;
a second interface with a number of vendors, by means of which the server is configured to transmit the order to the vendor identified in the order, receive a notification from the vendor indicating that the order has been accepted, and subsequently receive a notification from the vendor that the order is ready for fulfillment;
a third interface with a number of delivery providers, by means of which the server is configured to transmit a delivery instruction to a delivery provider able to fulfil the delivery, and receive a notification from the delivery provider that the delivery has been fulfilled,
wherein the server is configured, upon fulfillment of the delivery to:
   compute a delivery fee due to the delivery provider for delivery of the item based on a pre-set delivery fee formula,
   update a ledger account of the delivery provider with the delivery fee,
   update a ledger account of the vendor with the price for the item minus the delivery fee,
and wherein the server is configured, at regular intervals, to determine the amount owed between the vendor and the delivery provider and optionally instruct a payment gateway to facilitate settlement thereof.

Further features of the invention provide for the remotely accessible server to be accessible by means of user credentials to the vendors and delivery providers; for the vendors and delivery providers to be enabled to create and manage roles for authorized users; for access to the server to be determined by the role of a user; for different roles to be assigned to various levels of authorization; and for the different roles to be assigned a hierarchical status and a user's access to the server to be determined by the position of the role in the hierarchy.

Yet further features of the invention provide for roles with sufficient authorization to be able to input information such as the pre-set delivery fee formula and/or a delivery agent fee formula.

### BRIEF DESCRIPTION OF THE DRAWINGS

The invention will now be described, by way of example only with reference to the accompanying representations in which:

FIG. 1 is a block diagram of a system for processing an electronic order according to a first embodiment of the invention;

FIG. 2 is a block diagram of a system for processing an electronic order according to a second embodiment of the invention;

FIG. 3 is a flow chart of a method of processing an electronic order according to the invention;

FIG. 4 is a block diagram illustrating how the system for processing en electronic order according to the invention enables various entities to integrate into the system; and

FIG. 5 is an organogram of role functionality.

### DETAILED DESCRIPTION WITH REFERENCE TO THE DRAWINGS

The invention relates to a system and method for processing electronic orders from a plurality of consumers, the orders being placed through a plurality of ordering entities for items sourced from a plurality of vendors and the items being delivered to the consumers by means of a plurality of delivery providers.

The system includes a remotely accessible server configured to, through a first interface with an ordering entity, receive an order placed by a consumer with the ordering entity. The order includes at least an identification of the item ordered, delivery details, a price for the item and a vendor from whom the item is desired. The ordering entity is selected from a mobile device application, a call centre, an electronic commerce website, a point of sale or the like. In a preferred embodiment of the invention, the first interface includes an application program interface that defines the format with which the ordering entity must transmit the order to the server so as to ensure that all orders placed by the various ordering entities are placed in the same way with the server.

The server is further configured to, through a second interface with a number of vendors, transmit the order to the vendor from whom the item is desired and receive a notification from the vendor indicating that the order has been accepted. Once the item has been prepared and/or processed and is ready for delivery, the vendor transmits another notification to the server indicating that the order is ready for fulfillment.

Upon receiving the notification that the order is ready for fulfillment, the server is configured to, through a third interface with a number of delivery providers, transmit a delivery instruction to a delivery provider who is able to fulfil the delivery. Once the delivery has been fulfilled, the delivery provider transmits a notification to the server indicating that the delivery has been fulfilled. In order to facilitate delivery of the ordered items, the delivery provider is able to include with the server the details of multiple delivery agents who perform the actual delivery of the items.

It will be appreciated that the items ordered by consumers may be either physical or virtual items and that where the item is a physical item, physical delivery thereof will be required whereas where the item is a virtual item, delivery thereof may be done through an electronic communications channel.

In a preferred embodiment of the invention, the vendor receives a notification of the fulfillment of the delivery so as to enable the vendor to track the order from the time the order is placed until it is fulfilled. All orders of a vendor are preferably displayed on a visual display of the vendor so as to provide the vendor with all orders that have been placed and at which point in the process the various orders are.

Furthermore, the server is configured to, upon fulfillment of the delivery, compute a delivery fee due to the delivery provider for the delivery of the item based on a pre-set delivery fee formula, update a ledger account of the delivery provider with the delivery fee and update a ledger account of the vendor with the price for the item minus the delivery fee. To this end, the server further includes ledger accounts for each delivery agent whose details have been included by the delivery provider, and the ledger account of a specific delivery agent is updated upon that delivery agent fulfilling a delivery.

In order to balance the various ledger accounts, the server, at regular intervals, determines the amounts owed between the vendors and delivery providers and preferably instructs a payment gateway to facilitate settlement thereof so as to balance the ledger accounts.

The orders placed with an ordering entity and conveyed to the server through the first interface preferably include a geographic location of the consumer, and which location may be obtained from a GPS coordinate of a geo-location feature of a mobile device application, an address provided by the consumer, or the like. The server is configured to identify a retail outlet of a vendor which is closest to the consumer's location to thereby reduce the time required for delivery of the ordered item to take place.

The delivery fee due to a delivery provider and the delivery agent fee due to a delivery agent may be based on a fixed basis fee or on a basic fee plus an additional fee per kilometer that the delivery agent has to derive in order to deliver the item to the consumer. In a preferred embodiment, the server computes the delivery fee as soon as it receives the order and the consumer's geographic location. In the embodiment, the server will be able to provide the delivery fee to the ordering entity, and the ordering entity will provide the delivery fee to the consumer so that the consumer can decide whether to have the item delivered for the delivery fee, or rather collect the item him- or herself.

The remotely accessible server may be accessible to vendors and/or delivery providers by means of one of the interfaces. Access to the server will require a vendor or delivery provider to provide a pre-set user credential, and will enable the vendors and/or delivery providers to create and manage roles for authorized users. Access to the server will be determined by the role of the user, wherein each role will be assigned a hierarchical status, and the position of the role in the hierarchy will determine the user's access to the server. A role sufficiently high up in the hierarchy will therefore have sufficient authority and may be able to input information into the server. Information that may be input may include the pre-set delivery fee formula, a delivery agent fee formula according to which the delivery agent fee is determined or the like.

It will be appreciated that the system in accordance with the invention allows for the integration of various entities, such as vendors, delivery agents, delivery providers, ordering entities and payment gateway and facilitates the placement of orders from these entities seamlessly. Furthermore, it will be appreciated that the system allows for the determination of fees due to each of the integrated entities in real-time, thus allowing for accurate determination of fees due to an entity.

Embodiments of the invention will now be described with reference to the accompanying drawings.

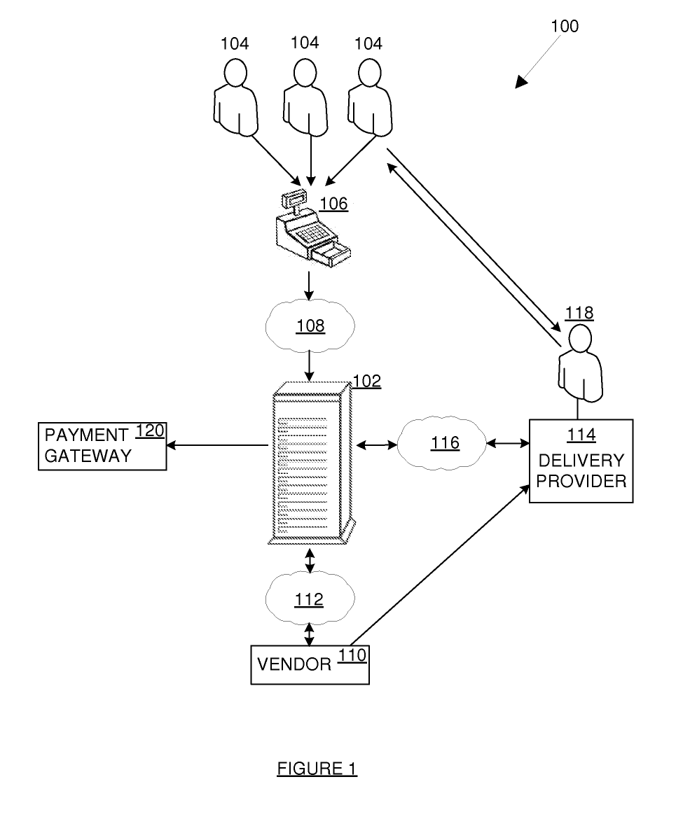

FIG. 1 illustrates a block diagram of a first embodiment of a system (100) for processing an electronic order in accordance with the invention. The system includes a remotely accessible server (102) which is configured to receive orders placed by consumers (104) with an ordering entity (106) through a first interface (108). The ordering entity (106) may be a mobile device application, a call centre, an electronic commerce website or a point of sale (POS) and the order received by the server (102) includes at least an identification of the item ordered, delivery details, a price for the item and a vendor (110) from whom the item is desired. In the embodiment illustrated in FIG. 1, the ordering entity (106) is a POS device. Further, in a preferred embodiment of the invention, the first interface (108) is a secure internet connection which includes an application program interface that defines the format with which the ordering entity (106) must transmit the order to the server (102) so as to ensure that all orders placed by the various ordering entities (106) are placed in the same way with the server (102).

Once the server (102) has received an order from an ordering entity (106), the server (102) transmits the order to a vendor (110) from whom the item is desired by means of a second interface (112). The vendor (110) may be any one of a retail store, an electronic commerce website, a service provider or the like, and the second interface maybe a secure internet connection. Upon acceptance of the order by the vendor (110), the vendor (110) transmits a notification to the server (102) that the order has been accepted, and subsequently once the item has been prepared and/or processed and is ready for delivery, the vendor (110) transmits another notification to the server (102) indicating that the order is ready for fulfillment.

As soon as the server (102) receives the notification that the order is ready for fulfillment, the server (102) transmits a delivery instruction to a delivery provider (114) who is able to fulfil the delivery, by means of a third interface (116) which may also be a secure internet connection, or an email, messaging or other communication channel. In order to facilitate delivery of ordered items, the delivery providers (114) are able to include with the server (102) the details of multiple delivery agents (118) who perform the actual delivery of the items.

Where the item ordered by a consumer is physical item, physical delivery thereof will be required, whereas where the item is a virtual item, delivery thereof may be done through an electronic communications channel. Thus, where the item is a virtual item, the delivery provider (114) and the vendor (110) may be the same entity. In the embodiment illustrated in FIG. 1, the item ordered is a physical item and thus requires physical delivery by a delivery agent (118).

Once the delivery has been fulfilled, the delivery provider (114) transmits a notification to the server (102) indicating that the delivery has been fulfilled. In order to enable quick delivery of ordered items, the orders placed with an ordering entity (106) and conveyed to the server (102) include a geographic location of the consumer (104). The location of the consumer (104), such as a physical address, may be provided by the consumer (104) when placing the order, alternatively, the location may be obtained from a GPS coordinate of a geo-location feature of a mobile device application. The server (102) is configured to identify a retail outlet of a vendor (110) which is closest to the consumer's (104) location thereby reducing the time required for the delivery of the ordered item to take place.

In a preferred embodiment of the invention, the vendor (110) receives a notification of the fulfillment of the delivery from the server (102), so as to enable the vendor (110) to track the order from the time the order is placed until it is fulfilled. In order to facilitate fast and convenient tracking of orders, a vendor (110) may have a visual display (not shown) displaying all of the vendor's (110) orders as well as the various stages of fulfillment at which the orders are.

Upon receipt of the notification that delivery has been fulfilled, the server (102) computes a delivery fee that is due to the delivery provider (114) for the delivery of the item based on a pre-set delivery fee formula, updates a ledger account of the delivery provider (114) with the delivery fee and updates a ledger account of the vendor (110) with the price for the item minus the delivery fee. Where the item requires physical delivery, as illustrated in the embodiment in FIG. 1, the server (102) further includes ledger accounts for each delivery agent (118), and the ledger account of a specific delivery agent (118) is updated upon that delivery agent (118) fulfilling a delivery.

In order to balance the various ledger accounts within the system (100), the server (102) determines, at a regular basis such as monthly, weekly or daily, the amounts owed between the vendors (110) and the delivery providers (114) as well as the delivery providers (114) and the delivery agents (118), and instructs a payment gateway (120) to facilitate settlement between the various parties (110, 114, 118).

The system (100) further provides for consumers (104) to pay for the items ordered by means of an electronic payment channel such as a credit card (card present or card not present), debit card, electronic banking transfer or other electronic payment methods, or by means of directly paying the delivery agent (118) upon delivery of the item ordered. In the embodiment illustrated in FIG. 1, the consumer (104) has elected to pay on delivery, typically by cash, and as the delivery agent (106) receives the cash, the server (102) updates the delivery agent's (118) ledger account accordingly. Thus, where settlement has to take place, the delivery agent (118) will owe money to the vendor (110) and the delivery provider (114), and the payment gateway (120) will accordingly be instructed to withdraw the owed money from a bank account (not shown) of the delivery agent (118) and pay it into bank accounts (not shown) of the vendor (110) and the delivery provider (114).

It will be appreciated that the server (102) may be enabled to directly communicate with the delivery agents (118) of a delivery provider (114) by means of a mobile phone application installed on a mobile phone (not shown) of the delivery agent (118). In this way, the server (102) may be configured to determine the availability and location of a delivery agent (118) and transmit delivery instructions directly to the delivery agent (118), preferably to a delivery agent (118) closest to the retail outlet of the vendor (110) from whom the item is desired. The delivery agent (118) would further be enabled to transmit a notification directly to the server (102) once delivery has been fulfilled, however, it is envisaged that although the delivery provider (114) may be partially circumvented in this way, that the delivery provider (114) would be able to track all deliveries similar to the tracking of orders by the vendor (110) as discussed above.

It will further be appreciated that an ordering entity (106) may also from part of a vendor (110), for example where the ordering entity (106) is a POS device in a retail outlet of the vendor (110). The order would be processed in the normal way, and could either be collected by the consumer (104) from the retail outlet or it could be delivered to the consumer (104) at a different location.

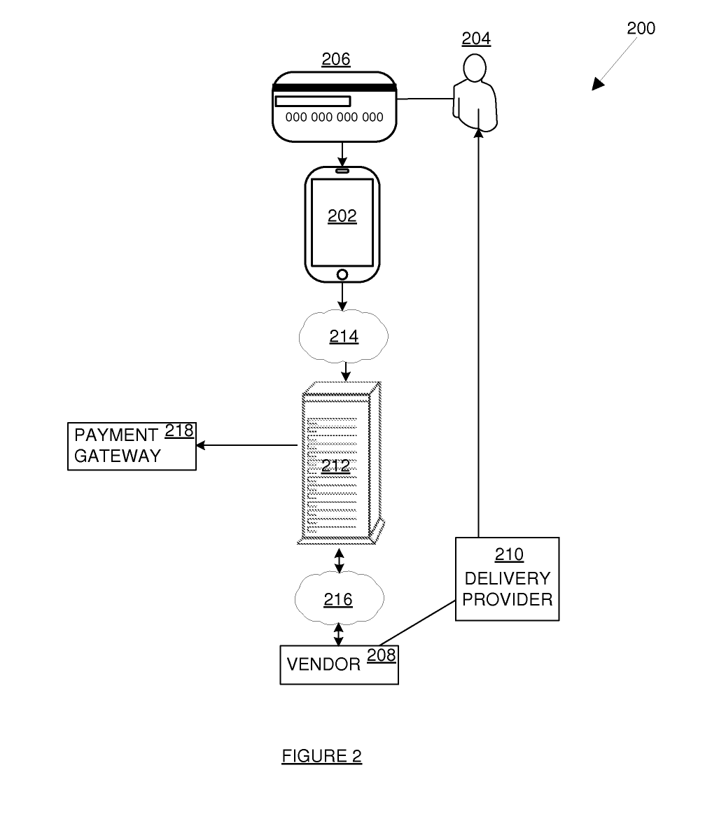

FIG. 2 illustrates a block diagram of a second embodiment of a system (200) for processing an electronic order in accordance with the invention. The system (200) is similar to the system (100) illustrated in FIG. 1, however, in this embodiment, the ordering entity (202) is a mobile device application installed on a mobile device, and the consumer (204) has elected to effect payment by means of an electronic payment method, in this embodiment by using a credit card (206). Furthermore, the item ordered is a virtual item and can thus be delivered to the consumer (204) by means of an electronic communications channel and the vendor (208) and delivery provider (210) are the same entity.

The ordering process will follow the same procedure as described above with reference to FIG. 1, in that the consumer (204) will place an order for an item with an ordering entity (202), which then conveys the order to the remotely accessible server (212) by means of a first interface (214). Through a second interface (216), the server (212) then transmits the order to a vendor (208) identified in the order, and the vendor (208) transmits a notification to the server (212) once the order has been accepted and subsequently when the order is ready for fulfillment.

As the vendor (208) and delivery provider (210) are the same entity, the server (212) does not have to transmit a delivery instruction to the delivery provider (210), and the vendor (208) and/or delivery provider (210) delivers the item to the consumer (204) upon which a notification is transmitted to the server (212) indicating that delivery has been fulfilled.

Furthermore, where the consumer (204) has elected to pay by means of an electronic payment method, such as a credit card (206), it is envisaged that the payment amount will merely be reserved on the consumer's (204) bank account (not shown) and upon settlement by the payment gateway (218), the amount will be withdrawn from the bank account and the applicable parties paid.

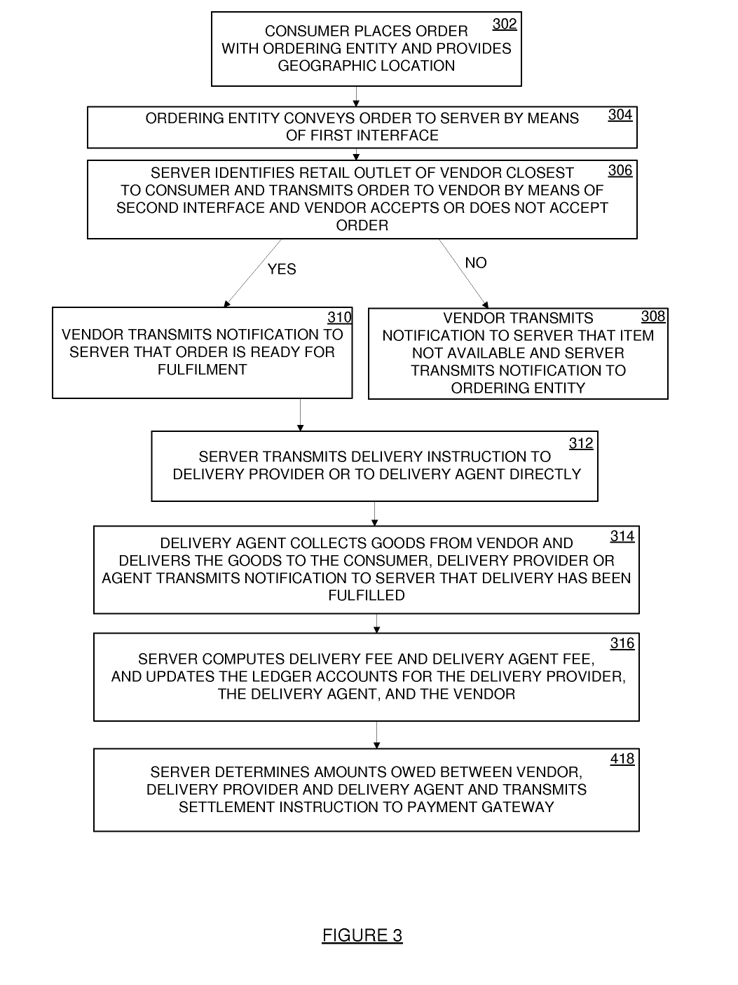

FIG. 3 illustrates a flow diagram of a method for processing an electronic order making use of the system illustrated in FIG. 1. At a first stage (302), a consumer (104) places and order for an item with an ordering entity (106). Due to the item being a physical item and thus requiring physical delivery thereof, the order placed by the consumer (104) includes a geographic location of the consumer (104), which may be the physical address of the consumer (104) or a location obtained from a GPS coordinate of a geo-location feature of a mobile device application.

At a next stage (304), the ordering entity (106) conveys the order to the remotely accessible server (102) by means of the first interface (108). The order conveyed to the server (102) includes at least an identification of the item ordered, delivery details, a price for the item and a vendor (110) from whom the item is desired.

At a next stage (306), the server (102) identifies a retail outlet of the vendor (110) from whom the item is desired and which is closest to the consumer's (104) location and transmits the order to the vendor (110) by means of the second interface (112), and receives a notification from the vendor (110) indicating that the order has been accepted.

Where the order is not accepted, typically where the ordered item is out of stock then, at a next stage (308), the vendor (110) transmits a notification to the server (102) to such effect, which then further transmits the notification to the ordering entity (106).

On the other hand, where the order is accepted and the item is available then, at a next stage (310), the vendor (110) transmits a notification to the server (102) indicating that the order is ready for fulfillment.

At a next stage (312), the server (102) transmits a delivery instruction to a delivery provider (114) that is able to fulfil the delivery by means of a third interface (116). At this stage, the delivery provider (114) will typically appoint a delivery agent (118) to perform the actual delivery of the goods. It is, however, also envisaged that instead of the server transmitting the delivery instruction to a delivery provider (114), the server may transmit the instruction to a delivery agent (118) directly.

At a next stage (314), the delivery agent (118) collects the item from the vendor (110) and delivers it to the consumer (104). Upon delivery of the item by the delivery agent (118), the delivery provider (114) (or alternatively the delivery agent (118)) transmits a notification to the server (102) that delivery has been fulfilled.

At a next stage (316), upon receipt of the delivery fulfillment notification, the server (102) computes a delivery fee due to the delivery provider (114) and a delivery agent fee due to the delivery agent (118) for the delivery of the item, updates the ledger account of the delivery provider (114) as well as the ledger account of the delivery agent (118) with the applicable fees, and updates the ledger account of the vendor (110) with the price for the item minus the delivery fee. As the consumer (104) has elected to pay by means of cash on delivery, the delivery agent (118) will have received the payment, and the server will update the various ledger accounts so that the in effect the delivery agent (118) owes money to the delivery provider (114) and the vendor (110).

It will be appreciated that computation of the fees due preferably takes place in real time as soon as the server is notified that a step in the fulfillment chain has been completed, thus once the item has been collected from the vendor and then again once the item has been delivered. The system therefore computes the fees and updates the ledger accounts of the appropriate parties substantially instantaneously and without requiring a manual accounting system to be implemented therefor.

At a next stage (318), which does not typically takes place after each order processing, but rather daily, weekly or monthly, the server (102) determines the amounts owed between the vendors (110), delivery providers (114) and delivery agents (118) and transmits a settlement instruction to a payment gateway (120), so as to settle the various amounts between the various parties (110, 114, 118).

The system further provides for vendors and delivery providers to create and manage roles for authorized users. The role assigned to a user will determine the user's access to the server and therefore the ability of the user to add or change the information provided to the server. The various types of roles are further assigned a hierarchical status, thus the higher up in the hierarchy, the higher the level of authorization and therefore the greater the access to the server.

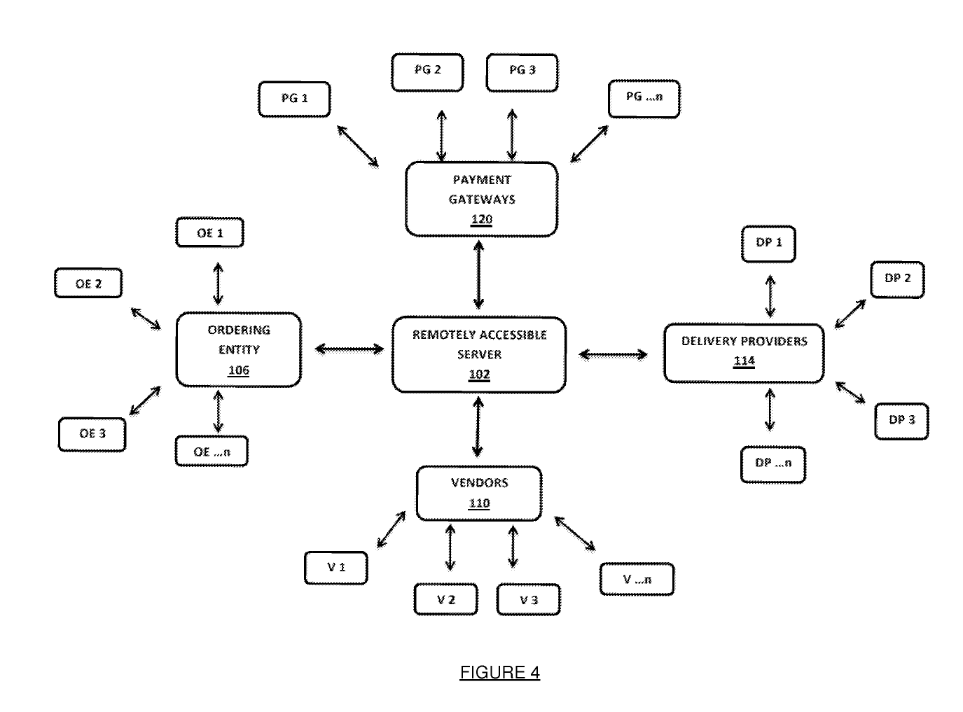

FIG. 4 illustrates how the system (100, 200) illustrated in FIGS. 1 and 2 enables the seamless integration of various entities, such as vendors (110), delivery providers (114), ordering entities (106) as well as payment gateways (120) with each other without requiring individual integration of each entity. Typically, where for example one vendor (110) intends to work with two different delivery providers (114), two different ordering entities (106) and one payment gateway (120), the vendor (110) would have to integrate his or her systems with each of these entities.

Integration with the remotely accessible server (102) will automatically provide an entity with access to all other entities that have been integrated with the server, thus with the example above, the vendor (110) would only have to integrate into to the remotely accessible server (102), and would thereby be automatically integrated into the two delivery providers (114), the two ordering entities (106) and the payment gateway (120).

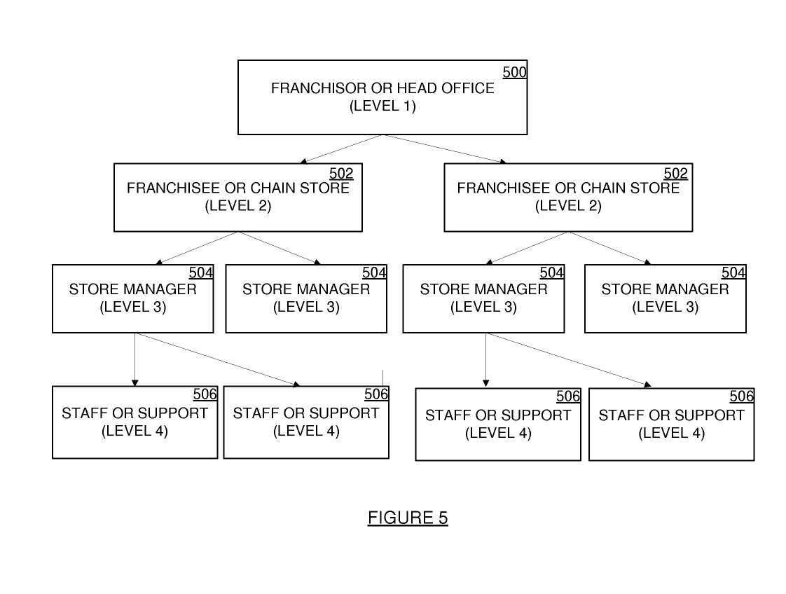

FIG. 5 shows an organogram of an example of a hierarchy where a franchisor has registered the entire franchise on the system. The role furthest up in the hierarchy would be assigned to the franchisor or head office (500), the next level would be assigned to the various franchisees or chain stores (502), the next step to the individual store managers (504) that run the various franchises and the lowest level would be assigned to the staff (506) that work at the individual retail outlets. In this way a registered user can insure that only authorized representatives are able to change any information which has been uploaded to the system server.

While the invention has been described with reference to particular embodiments, the scope of the invention is not limited to those embodiments and many variations exist.

1. A method for processing an electronic order, the method carried out at a remotely accessible server and comprising the steps of:
through a first interface with an ordering entity, receiving an order for an item placed by a consumer with the ordering entity, the order including an identification of the item ordered, delivery details, a price for the item, and a vendor from whom the item is desired;
through a second interface with a number of vendors, transmitting the order to the vendor identified in the order;
receiving a notification from the vendor indicating that the order has been accepted and subsequently receiving a notification from the vendor that the order is ready for fulfillment;
upon receiving a notification that the order is ready for fulfillment, through a third interface with a number of delivery providers, transmitting a delivery instruction to a delivery provider able to fulfil the delivery;
receiving a notification from the delivery provider that the delivery has been fulfilled;
computing a delivery fee due to the delivery provider for delivery of the item based on a pre-set delivery fee formula;
updating a ledger account of the delivery provider with the delivery fee;
updating a ledger account of the vendor with the price for the item minus the delivery fee; and
at regular intervals, determining the amount owed between the vendor and the delivery provider and optionally instructing a payment gateway to facilitate settlement thereof.

2. The method as claimed in claim 1, in which the ordering entity is selected from a mobile device application, a call centre, an electronic commerce website, and a point of sale device.

3. The method as claimed in claim 1, in which the first interface includes an application program interface that defines the format with which the ordering entity must transmit the order to the remotely accessible server.

4. The method as claimed in claim 1, in which the vendor receives notification of the fulfillment of the delivery so that the vendor is able to track the order from the time the order is placed until it is fulfilled.

5. The method as claimed in claim 4, in which the vendor is able to track each order on a visual display.

6. The method as claimed in claim 1, in which the delivery provider is able to include the details of multiple delivery agents with the remotely accessible server, for each delivery agent to have a ledger account with the remotely accessible server, and for the ledger account of a specific delivery agent to be updated upon that delivery agent fulfilling a delivery.

7. The method as claimed in claim 1, in which the item is a physical item and the delivery provider must physically deliver the item to the consumer.

8. The method as claimed in claim 1, in which the item is a virtual item and the delivery provider delivers the item to the consumer though an electronic communications channel.

9. The method as claimed in claim 1, in which the delivery details include a geographic location of the consumer, and the method includes the step of identifying a retail outlet of a vendor which is closest to the location of the consumer, thereby reducing the required travelling distance and time for delivery of the ordered item to take place.

10. The method as claimed in claim 9, in which the geographic location of the consumer is obtained from a GPS coordinate of a geo-location feature of a mobile device application.

11. A system for processing an electronic order, the system comprising a remotely accessible server having:
a first interface with an ordering entity, by means of which the server is configured to receive an order for an item placed by a consumer with the ordering entity, the order including an identification of an item ordered, delivery details, a price for the item, and a vendor from whom the item is desired;
a second interface with a number of vendors, by means of which the server is configured to transmit the order to the vendor identified in the order, receive a notification from the vendor indicating that the order has been accepted, and subsequently receive a notification from the vendor that the order is ready for fulfillment;
a third interface with a number of delivery providers, by means of which the server is configured to transmit a delivery instruction to a delivery provider able to fulfil the delivery, and receive a notification from the delivery provider that the delivery has been fulfilled;
wherein the server is configured to:
compute a delivery fee due to the delivery provider for delivery of the item based on a pre-set delivery fee formula;
update a ledger account of the delivery provider with the delivery fee;
update a ledger account of the vendor with the price for the item minus the delivery fee;
and wherein the server is configured, at regular intervals, to determine the amount owed between the vendor and the delivery provider and optionally instruct a payment gateway to facilitate settlement thereof.

12. The system as claimed in claim 11, wherein the remotely accessible server is accessible by means of user credentials to the vendors and delivery providers, and the vendors and delivery providers are able to create and manage roles for authorized users, with access to the server being determined by the role of a user.

13. The system as claimed in claim 12, wherein the roles for authorized users are assigned a hierarchical status, the position of the role in the hierarchy determining a user's access to the server, and a role with sufficient authorization being able to input information such as the pre-set delivery fee formula and a delivery agent fee formula.

14. A method of facilitating the integration of a number of different entities in an electronic commerce environment in which orders are processed, comprising, at a remotely accessible server:
integrating an entity with the server so that the entity and the server can communicate with each other through a first interface;
through the first interface, receiving a request from the entity to connect to one or more other entities which are also integrated with the server; and
by means of the server, connecting the entity to the one or more other entities without requiring any modification of the first interface;
so that an order involving multiple entities can be seamlessly processed by the server communicating with the connected entities.

15. A method as claimed in claim 14, wherein the entity is one of, and the other entities are one or more of: a payment gateway, a delivery provider, a vendor, and an ordering entity.
